(19) United States
(12) Patent Application Publication
(10) Pub. No.: US 2013/0109263 A1
(43) Pub. Date: May 2, 2013

(54) Abrasion-Resistant Nonwovens

(71) Applicants: Ali Yahiaoui, Roswell, GA (US); Anthony S. Spencer, Woodstock, GA (US)

(72) Inventors: Ali Yahiaoui, Roswell, GA (US); Anthony S. Spencer, Woodstock, GA (US)

(21) Appl. No.: 13/285,695

(22) Filed: Oct. 31, 2011

(51) Int. Cl. B32B 27/12; B05D 3/10; B05D 7/24

(52) U.S. Cl. 442/148; 427/489

(57) ABSTRACT

As described herein, an abrasion resistant nonwoven fabric includes fibers having an external surface covered with a treatment selected from the group consisting of organosilicone compounds applied by plasma treatment in inert gas without the presence of oxygen and acrylic monomers having a Tg greater than or equal to 20 degrees C. applied onto the nonwoven fabric and subsequently surface grafted and crosslinked via exposure to plasma glow discharge or e-beam without the presence of oxygen. The treated fabrics demonstrate improved abrasion resistance over untreated fabrics.

### BACKGROUND OF THE INVENTION

The manufacture of nonwoven fabrics for diverse applications has become a highly developed technology. Methods of manufacturing nonwoven fabrics include spunbonding, meltblowing, carding, airlaying, and so forth. It is not always possible, however, to produce by these methods a nonwoven fabric having all desired attributes for a given application. In many applications, durability is highly desirable for prolonging the useful life of articles that include nonwoven fabrics. While increasing basis weight of nonwoven fabrics is one method of increasing durability, increased basis weight results in increased costs. Accordingly, there is a need to improve the durability of nonwoven fabrics without increasing basis weight.

### SUMMARY OF THE INVENTION

Objects and advantages of the invention will be set forth in part in the following description, or may be obvious from the description, or may be learned through practice of the invention.

In one embodiment, an abrasion resistant nonwoven fabric includes fibers having an external surface covered with a treatment selected from the group consisting of organosilicone compounds applied by plasma treatment in inert gas without the presence of oxygen and acrylic monomers having a glass transition temperature (Tg) greater than or equal to 20 degrees C. applied onto the nonwoven fabric and subsequently surface grafted and crosslinked via exposure to plasma glow discharge or e-beam without the presence of oxygen.

In another embodiment, a process of making an abrasion resistant nonwoven fabric includes the steps of: i) providing a nonwoven fabric including fibers having an external surface; ii) applying a treatment selected from the group consisting of organosilicone compounds and acrylic monomers having a Tg greater than or equal to 20 degrees C. onto the nonwoven fabric; and iii) subsequently exposing the treatment to plasma glow discharge or e-beam in inert gas without the presence of oxygen to crosslink the treatment and form treated fibers.

In one aspect, the treated fibers of the nonwoven fabric have a hydrophobic outer surface. In another aspect, the fibers are thermoplastic fibers, optionally polypropylene fibers. In a further aspect, the nonwoven fabric comprises two layers of spunbond fibers on either side of a meltblown fiber layer.

In one aspect, the organosilicone compound on the external surface of the fibers has a thickness of about 0.1 microns to about 1.0 micron. In a further aspect, the treatment has a substantially uniform thickness on the external surface of the fibers.

In one aspect, the surface tension of the acrylic monomer is less than or equal to about 45 dynes/centimeter. In a further aspect, the crosslinked acrylic on the external surface of the fibers has a thickness of about 1 micron to about 7 microns.

In one aspect, the organosilicone compound may be hexamethyl disiloxane. In one aspect, the plasma glow discharge treatment and crosslinking takes place in an inert gas, optionally helium or argon.

Other features and aspects of the present invention are discussed in greater detail below.

### DETAILED DESCRIPTION OF REPRESENTATIVE EMBODIMENTS

### Definitions

As used herein the term “nonwoven fabric or web” refers to a web having a structure of individual fibers or threads which are interlaid, but not in an identifiable manner as in a knitted fabric. Nonwoven fabrics or webs have been formed from many processes such as for example, meltblowing processes, spunbonding processes, bonded carded web processes, and so forth, and may include multilayer laminates.

As used herein, the term “meltblown web” generally refers to a nonwoven web that is formed by a process in which a molten thermoplastic material is extruded through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin, et al., which is incorporated herein in its entirety by reference thereto for all purposes. Generally speaking, meltblown fibers may be microfibers that are substantially continuous or discontinuous, generally smaller than 10 microns in diameter, and generally tacky when deposited onto a collecting surface.

As used herein, the term “spunbond web” generally refers to a web containing small diameter substantially continuous fibers. The fibers are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al., which are incorporated herein in their entirety by reference thereto for all purposes. Spunbond fibers are generally not tacky when they are deposited onto a collecting surface. Spunbond fibers may sometimes have diameters less than about 40 microns, and are often between about 5 to about 20 microns.

As used herein, the term “multilayer laminate” means a laminate wherein some of the layers, for example, are spunbond and some meltblown such as a spunbond/meltblown/spunbond (SMS) laminate and others as disclosed in U.S. Pat. No. 4,041,203 to Brock et al., U.S. Pat. No. 5,169,706 to Collier, et al, U.S. Pat. No. 5,145,727 to Potts et al., U.S. Pat. No. 5,178,931 to Perkins et al. and U.S. Pat. No. 5,188,885 to Timmons et al. Such a laminate may be made by sequentially depositing onto a moving forming belt first a spunbond fabric layer, then a meltblown fabric layer and last another spunbond layer and then bonding the laminate in a manner described below. Alternatively, the fabric layers may be made individually, collected in rolls, and combined in a separate bonding step. Such fabrics usually have a basis weight of from about 0.1 to 12 osy (3 to 400 gsm), or more particularly from about 0.75 to about 3 osy. Multilayer laminates may also have various numbers of meltblown layers or multiple spunbond layers in many different configurations and may include other materials like films (F) or coform materials, e.g. SMMS, SM, SFS, etc.

As used herein, the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries. Examples of polymers include, by way of illustration only, polyolefins, such as polyethylene, poly(isobutene), poly(isoprene), poly(4-methyl-1-pentene), polypropylene, ethylene-propylene copolymers, ethylene-propylene-hexadiene copolymers, and ethylene-vinyl acetate copolymers; styrene polymers, such as poly(styrene), poly(2-methylstyrene), styrene-acrylonitrile copolymers having less than about 20 mole-percent acrylonitrile, and styrene-2,2,3,3,-tetrafluoropropyl methacrylate copolymers; halogenated hydrocarbon polymers, such as poly(chlorotrifluoroethylene), chlorotrifluoroethylene-tetrafluoroethylene copolymers, poly(hexafluoropropylene), poly(tetrafluoroethylene), tetrafluoroethylene-ethylene copolymers, poly(trifluoroethylene), poly(vinyl fluoride), and poly(vinylidene fluoride); vinyl polymers, such as poly(vinyl butyrate), poly(vinyl decanoate), poly(vinyl dodecanoate), poly(vinyl hexadecanoate), poly(vinyl hexanoate), poly(vinyl propionate), poly(vinyl octanoate), poly(heptafluoroisopropoxyethylene), poly(heptafluoroisopropoxypropylene), and poly(methacrylonitrile); acrylic polymers, such as poly(n-butyl acetate), poly(ethyl acrylate), poly[(1-chlorodifluoromethyl)tetrafluoroethyl acrylate], poly[di(chlorofluoromethyl)fluoromethyl acrylate], poly(1,1-dihydroheptafluorobutyl acrylate), poly(1,1-dihydropentafluoroisopropyl acrylate), poly(1,1-dihydropentadecafluorooctyl acrylate), poly(heptafluoroisopropyl acrylate), poly[5-(heptafluoroisopropoxy)pentyl acrylate], poly[11-(heptafluoroisopropoxy)undecyl acrylate], poly[2-(heptafluoropropoxy)ethyl acrylate], and poly(nonafluoroisobutyl acrylate); methacrylic polymers, such as poly(benzyl methacrylate), poly(n-butyl methacrylate), poly(isobutyl methacrylate), poly(t-butyl methacrylate), poly(t-butylaminoethyl methacrylate), poly(dodecyl methacrylate), poly(ethyl methacrylate), poly(2-ethylhexyl methacrylate), poly(n-hexyl methacrylate), poly(phenyl methacrylate), poly(n-propyl methacrylate), poly(octadecyl methacrylate), poly(l,1-dihydropentadecafluorooctyl methacrylate), poly(heptafluoroisopropyl methacrylate), poly(heptadecafluorooctyl methacrylate), poly(1-hydrotetrafluoroethyl methacrylate), poly(1,1-dihydrotetrafluoropropyl methacrylate), poly(1-hydrohexafluoroisopropyl methacrylate), and poly)t-nonafluorobutyl methacrylate); and polyesters, such a poly(ethylene terephthalate) and poly(butylene terephthalate).

As used herein, the term “multicomponent fibers” generally refers to fibers that have been formed from at least two polymer components. Such fibers are typically extruded from separate extruders, but spun together to form one fiber. The polymers of the respective components are typically different, but may also include separate components of similar or identical polymeric materials. The individual components are typically arranged in substantially constantly positioned distinct zones across the cross-section of the fiber and extend substantially along the entire length of the fiber. The configuration of such fibers may be, for example, a side-by-side arrangement, a pie arrangement, or any other arrangement. Multicomponent fibers and methods of making the same are taught in U.S. Pat. No. 5,108,820 to Kaneko, et al., U.S. Pat. No. 4,795,668 to Kruege, et al., U.S. Pat. No. 5,382,400 to Pike, et al., U.S. Pat. No. 5,336,552 to Strack, et al., and U.S. Pat. No. 6,200,669 to Marmon, et al., which are incorporated herein in their entirety by reference thereto for all purposes. The fibers and individual components containing the same may also have various irregular shapes such as those described in U.S. Pat. No. 5,277,976 to Hogle, et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al., which are incorporated herein in their entirety by reference thereto for all purposes.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

In general, the present disclosure is directed to a nonwoven web of synthetic fibers treated with an abrasion-resistant treatment. The web exhibits improved abrasion resistance. For example, the nonwoven web demonstrates improved abrasion resistance when subjected to a Taber abrasion test.

A. Substrates The substrates to which the abrasion-resistant treatment may be applied include any known sheet-like substrate, such as nonwoven webs (e.g., spunbond webs, meltblown webs, and so forth), woven webs, films, foams, and so forth. Suggested nonwoven substrates include, but are not limited to, nonwoven fabrics including laminates that include at least one meltblown (M) layer and/or at least one spunbond layer (S), spunbond/meltblown (SM) laminates, spunbond/meltblown/spunbond (SMS) laminates, spunbond/film/spunbond (SFS) laminates, spunbond/film/spunbond/meltblown/spunbond (SFSMS) laminates and spunbond/film/film/spunbond (SFFS) laminate and laminates and combinations thereof. The substrate may contain a single layer or multiple layers and may also contain additional materials such that it is considered a composite. In one embodiment, the substrate may be a nonwoven web of synthetic fibers. The synthetic fibers can generally be hydrophobic fibers. The term “hydrophobic ” is used herein to mean having a surface resistant to wetting, or not readily wet, by water, i.e., having a lack of affinity for water. In one particular embodiment, the fibers of the nonwoven web are primarily hydrophobic synthetic fibers. For example, greater than about 90% of the fibers of the web can be hydrophobic synthetic fibers, such as greater than about 95%. In one embodiment, substantially all of the fibers of the nonwoven web (i.e., greater than about 98%, greater than about 99%, or about 100%) are hydrophobic synthetic fibers.

The nonwoven web can be made by any number of processes. As a practical matter, however, the nonwoven fabrics and the fibers that make up nonwoven fabrics usually will be prepared by a melt-extrusion process and formed into the nonwoven fabric. The term melt-extrusion process includes, among others, such well-known processes as meltblowing and spunbonding. Other methods for preparing nonwoven fabrics are, of course, known and may be employed. Such methods include air laying, wet laying, carding, and so forth. In some cases it may be either desirable or necessary to stabilize the nonwoven fabric by known means, such as thermal point bonding, through-air bonding, and hydroentangling.

As stated, the nonwoven web can primarily include synthetic fibers, particularly synthetic hydrophobic fibers, such as polyolefin fibers. In one particular embodiment, polypropylene fibers can be used to form the nonwoven web. The polypropylene fibers may have a denier per filament of about 1.5 to 2.5, and the nonwoven web may have a basis weight of about 17 grams per square meter (0.5 ounce per square yard). Furthermore, the nonwoven fabric may include bicomponent or other multicomponent fibers. Exemplary multicomponent nonwoven fabrics are described in U.S. Pat. No. 5,382,400 issued to Pike et al., U.S. Publication no. 2003/0118816 entitled “High Loft Low Density Nonwoven Fabrics Of Crimped Filaments And Methods Of Making Same” and U.S. Publication no. 2003/0203162 entitled “Methods For Making Nonwoven Materials On A Surface Having Surface Features And Nonwoven Materials Having Surface Features” which are hereby incorporated by reference herein in their entirety.

Sheath/core bicomponent fibers where the sheath is a polyolefin such as polyethylene or polypropylene and the core is polyester such as poly(ethylene terephthalate) or poly(butylene terephthalate) can also be used to produce carded fabrics or spunbonded fabrics. The primary role of the polyester core is to provide resiliency and thus to maintain or recover bulk under/after load. Bulk retention and recovery plays a role in separation of the skin from the absorbent structure. This separation has shown an effect on skin dryness. The combination of skin separation provided with a resilient structure along with a treatment such of the present invention can provide an overall more efficient material for fluid handling and skin dryness purposes.

As stated, the nonwoven web can be included as an outer surface of a laminate. When included as part of a laminate, the nonwoven web generally provides a more cloth-like feeling to the laminate. For example, a film-web laminate can be formed from the nonwoven web overlying a film layer. In one embodiment, for instance, the nonwoven web is thermally laminated to the film to form the film-web laminate. However, any suitable technique can be utilized to form the laminate. Suitable techniques for bonding a film to a nonwoven web are described in U.S. Pat. No. 5,843,057 to McCormack; U.S. Pat. No. 5,855,999 to McCormack; U.S. Pat. No. 6,002,064 to Kobylivker, et al.; U.S. Pat. No. 6,037,281 to Mathis, et al.; and WO 99/12734, which are incorporated herein in their entirety by reference thereto for all purposes.

The film layer of the laminate is typically formed from a material that is substantially impermeable to liquids. For example, the film layer may be formed from a thin plastic film or other flexible liquid-impermeable material. In one embodiment, the film layer is formed from a polyethylene film having a thickness of from about 0.01 millimeter to about 0.05 millimeter. For example, a stretch-thinned polypropylene film having a thickness of about 0.015 millimeter may be thermally laminated to the nonwoven web.

In addition, the film layer may be formed from a material that is impermeable to liquids, but permeable to gases and water vapor (i.e., “breathable”). This permits vapors to pass through the laminate, but still prevents liquid exudates from passing through the laminate. The use of a breathable laminate is especially advantageous when the laminate is used as an outercover of an absorbent article to permit vapors to escape from the absorbent core, but still prevents liquid exudates from passing through the outer cover. For example, the breathable film may be a microporous or monolithic film.

The film may be formed from a polyolefin polymer, such as linear, low-density polyethylene (LLDPE) or polypropylene. Examples of predominately linear polyolefin polymers include, without limitation, polymers produced from the following monomers: ethylene, propylene, 1-butene, 4-methyl-pentene, 1-hexene, 1-octene and higher olefins as well as copolymers and terpolymers of the foregoing. In addition, copolymers of ethylene and other olefins including butene, 4-methyl-pentene, hexene, heptene, octene, decene, etc., are also examples of predominately linear polyolefin polymers.

In one embodiment, the laminate consists only of two layers: the nonwoven web and the film. On the other hand, in some embodiments, other layers may be included in the laminate, so long as the nonwoven web defines an outer surface of the laminate for receiving the abrasion resistant treatment. When present, the other layer(s) of the laminate can include nonwoven webs, films, foams, etc.

In one particular embodiment, the abrasion-resistant nonwoven web may be suitable for use as an infection control product, for example, medically oriented items such as surgical gowns and drapes, face masks, head coverings like bouffant caps, surgical caps and hoods, footwear like shoe coverings, boot covers and slippers, wound dressings, bandages, sterilization wraps, wipers, garments like lab coats, coveralls, aprons and jackets, patient bedding, stretcher and bassinet sheets, and the like. Infection control products may be susceptible to abrasion, and therefore may suitably benefit from application of an abrasion-resistant treatment as described herein to the infection control product.

In another particular embodiment, the nonwoven web is suitable for use as a component of an absorbent article, for example, an outer layer of a backsheet laminate (i.e., outercover) of an absorbent article. As used herein, an “absorbent article” refers to any article capable of absorbing water or other fluids. Examples of some absorbent articles include, but are not limited to, personal care absorbent articles, such as diapers, training pants, absorbent underpants, adult incontinence products, feminine hygiene products (e.g., sanitary napkins), swim wear, baby wipes, and so forth; medical absorbent articles, such as garments, fenestration materials, underpads, bandages, absorbent drapes, and medical wipes; food service wipers; clothing articles; and so forth. Materials and processes suitable for forming such absorbent articles are well known to those skilled in the art. For example, in one particular embodiment, the backsheet of an absorbent article is a laminate of a liquid impervious film attached to a nonwoven web of polyolefin fibers. The nonwoven web may be on the outside of the absorbent article. Suitable, the absorbent article may be made more abrasion-resistant by application of an abrasion-resistant treatment as described herein to the nonwoven web of the backsheet.

In a further embodiment, a nonwoven material may serve as a component of a packaging material. As packaging materials may be susceptible to abrading, packaging materials may suitably be made more abrasion-resistant by application of an abrasion-resistant treatment as described herein.

In an event further embodiment, a nonwoven material may serve as a component of a protective garment. Protective apparel or garments, such as coveralls and gowns, designed to provide barrier protection to a wearer are well known in the art. Such protective garments are used in situations where isolation of a wearer from a particular environment is desirable, or it is desirable to inhibit or retard the passage of hazardous liquids and biological contaminates through the garment to the wearer. As such, components of the garment may be susceptible to abrading. Suitably, components of protective apparel may be made more abrasion-resistant by application of an abrasion-resistant treatment as described herein.

B. Abrasion-Resistant Treatments

The substrate further includes an abrasion-resistant treatment applied to the surface of the substrates. When the substrate is a fibrous nonwoven, the abrasion-resistant treatment is applied to the external surfaces of the fibers in the nonwoven.

In one embodiment, the abrasion-resistant treatment may be selected from the group consisting of organosilicone compounds applied by plasma treatment in inert gas without the presence of oxygen and acrylic monomers having a glass transition temperature (Tg) greater than or equal to 20 degrees C. applied onto the nonwoven fabric and subsequently surface grafted and crosslinked via exposure to plasma treatment and crosslinking without the presence of oxygen. In other embodiments, the acrylic monomers may suitably have a Tg greater than or equal to 25 degrees C., or more suitably greater than or equal to 30 degrees C., or even more suitably greater than or equal to 35 degrees C.

Suitable acrylic monomers include 3,3,5-Trimethyl cyclohexyl Acrylate, Acrylate Ester, Acrylic Ester, Diethylene Glycol Methyl Ether Methacrylate, Propoxylated2 Neopentyl Glycol Diacrylate, Isobornyl Acrylate, Propoxylated2 Neopentyl Glycol Diacrylate, High Purity Tripropylene Glycol Diacrylate, Dipropylene Glycol Diacrylate, Dicyclopentadienyl Methacrylate, Propoxylated6 Trimethylolpropane Triacrylate, Ethoxylated4 Nonyl Phenol Methacrylate, Cyclic Trimethylolpropane Formal Acrylate, Tripropylene Glycol Diacrylate, Polypropylene Glycol Monomethacrylate, Dodecane Diacrylate, 1,3-Butylene Glycol Diacrylate, Alkoxylated Cyclohexane Dimethanol Diacrylate, Acrylic Ester, Trifunctional Acid Ester, Alkoxylated Aliphatic Diacrylate, Ethoxylated4 Bisphenol A Dimethacrylate, Ethoxylated6 Bisphenol A Dimethacrylate, 1,6 Hexanediol Diacrylate, 1,6 Hexanediol Diacrylate, Trifunctional Acrylate Ester, Di-Trimethylolpropane Tetraacrylate, High Purity Trimethylolpropane Triacrylate, Low Viscosity Trimethylolpropane Triacrylate, Trimethylolpropane Triacrylate, Aqueous Zinc Acrylate Functional Intermediate, Tris(2-Hydroxy Ethyl)Isocyanurate Triacrylate, Ethoxylated4 Bisphenol A Diacrylate, Alkoxylated Hexanediol Diacrylate, Cyclohexane Dimethanol Diacrylate, Alkoxylated Trifunctional Acrylate Ester, Aqueous Zinc Acrylate Functional Intermediate, Alkoxylated Cyclohexane Dimethanol Diacrylate, Pentaerythritol Triacrylate, Dipentaerythritol Pentaacrylate, Low Viscosity Dipentaerythritol Pentaacrylate, Ethoxylated2 Bisphenol A Dimethacrylate, Pentaacrylate Ester, Ethoxylated20 Trimethylolpropane Triacrylate, and Ethoxylated3 Bisphenol A Diacrylate.

In one embodiment, the organosilicone compound may be hexamethyl disiloxane (HMDSO).

The abrasion-resistant treatment is topically applied to the nonwoven at an add-on level that suitably improves the abrasion-resistance of the nonwoven material. The basis weight of the abrasion-resistant treatment may be from about 0.1 to about 6 grams per square meter, optionally from about 0.1 to about 4 grams per square meter. The thickness of the abrasion-resistant treatment on the surface of the fibers of the nonwoven material may be from about 0.1 to about 6 micrometers, optionally from about 0.1 to about 4 micrometers.

The particular method of applying the abrasion-resistant treatment to the nonwoven web can be any suitable treatment application method for the abrasion-resistant treatment. Desirably, the treatment application method includes the steps of providing a nonwoven fabric comprising fibers having an external surface, applying a treatment selected from the group consisting of organosilicone compounds applied by plasma treatment in inert gas without the presence of oxygen and acrylic monomers having a Tg greater than or equal to 25 degrees C. applied by plasma treatment and crosslinking without the presence of oxygen to form treated fibers.

Suitably, the nonwoven web may be pre-treated by a plasma system. After the optional pre-treatment, a flash evaporation system may be used to deliver the monomer inside a vacuum chamber. The nonwoven web is delivered to the vacuum chamber on a cooled drum upon which the nonwoven web is placed. Inside the chamber, a monomer, such as, for example, an acrylic monomer, condenses onto the nonwoven web as the nonwoven web passes through the chamber on the chilled drum. The nonwoven web treated with the monomer is then exposed to a second plasma or e-beam source for graft polymerization or curing. The monomer application process is described in further detail in U.S. Pat. No. 6,468,595 to Mikhael et al., the contents of which are incorporated herein by reference for all purposes.

Desirably, after application of the abrasion-resistant treatment the treated fibers have a hydrophobic outer surface. To that end, suitably the surface tension of the acrylic monomer is less than or equal to about 45 dynes/centimeter, more suitably less than or equal to about 40 dynes/centimeter, and even more suitably less than or equal to about 35 dynes/centimeter. Further toward the end of maintaining a hydrophobic outer surface on the fibers, the plasma treatment and crosslinking desirably takes place in an inert gas, suitably helium, argon, or other inert gas.

Suitably, after application of an organosilicone compound to the nonwoven fabric the organosilicone compound on the external surface of the fibers has a thickness from about 0.1 microns to about 1.0 micron, more suitably from about 0.1 to about 0.5 microns, and even more suitably from about 0.1 to about 0.3 microns.

Suitably, after application of the crosslinked acrylic to the nonwoven fabric the crosslinked acrylic on the external surface of the fibers has a thickness from about 1 micron to about 7 microns, more suitably from about 1 micron to about 5 microns, and even more suitably from about 1 micron to about 3 microns.

Desirably the treatment has a substantially uniform thickness on the external surface of the fibers.

Application of the abrasion-resistant treatment to the surface of the nonwoven web suitably improves (increases) the abrasion-resistance of the treated nonwoven web as measured by the Taber abrasion test. For example, the Taber abrasion of the treated materials, measured as described below, may suitably be increased as compared to untreated samples by from about 1 to about 10 cycles, more suitably from about 3 to about 10 cycles, and even more suitably from about 5 to about 10 cycles.

### Test Methods

Taber Abrasion: Taber Abrasion resistance measures the abrasion resistance in terms of destruction of the fabric produced by a controlled, rotary rubbing action. Abrasion resistance is measured in accordance with Method 5306, Federal Test Methods Standard No. 191A, except as otherwise noted herein. Only a single wheel is used to abrade the specimen. A 12.7×12.7-cm specimen is clamped to the specimen platform of a Taber Standard Abrader (Model No. 504 with Model No. E-140-15 specimen holder) having a rubber wheel (No. H-18) on the abrading head and a 500-gram counterweight on each arm. The loss in breaking strength is not used as the criteria for determining abrasion resistance. The results are obtained and reported in abrasion cycles to failure where failure was deemed to occur at that point where a 0.5-cm hole is produced within the fabric.

Glass transition temperature (Tg): The glass transition temperature (Tg) may be determined using differential scanning calorimetry (“DSC”) in accordance with ASTM D-3417 as is well known in the art. Such tests may be employed using a THERMAL ANALYST 2910 Differential Scanning Calorimeter (outfitted with a liquid nitrogen cooling accessory) and with a THERMAL ANALYST 2200 (version 8.10) analysis software program, which are available from T.A. Instruments Inc. of New Castle, Del.

Surface tension: The surface tension of the treatment monomers may be obtained in accordance with the method described in ASTM D1331-89 as is well known in the art. Such tests may be employed using a precision torsion balance such as a Byk dynometer. As provided in the method, a platinum ring, which is attached to the tensiometer, is brought into planar contact with the surface of the liquid. Perpendicular extraction of the ring from the liquid surface results in a force which is recorded by the tensiometer as surface tension in dynes/cm.

### EXAMPLES

Nonwoven materials (Spunbond/meltblown/spunbond samples) were treated with abrasion-resistant acrylic treatments as set forth in Table 2. Substrate 1 was a 1.2 gsm polypropylene SMS sample. Substrate 2 was a 1.85 gsm polypropylene SMS sample. The monomers applied are identified in Table 1 below. All monomers are available from Sartomer Company, Inc. of Exton, Pa., USA.

TABLE 1
List of acrylic monomers

| | | | Surface |
|---|---|---|---|
| | | | Tension |
| Brand | | | (dynes/cm at |
| name | Chemical name | Tg (° C.) | 20° C. |
| SR-9003 | Propoxylated | 32 | 32 |
| | neopentyl glycol | | |
| | diacrylate | | |
| SR-9012 | Trifunctional acrylate | 64 | n/a |
| | ester | | |
| SR-351 | Trimethyl propane | 62 | 36.1 |
| | triacrylate | | |
| SR-531 | Cyclic trimethyl | 32 | n/a |
| | propane formal | | |
| | acrylate | | |
| CD-262 | 1,12 dodecanediol | 57 | n/a |
| | dimethacrylate | | |

TABLE 2
Acrylic Monomer Examples

| | | Pre- | Plasma | | Monomer | | E-beam | Coating | Taber |
|---|---|---|---|---|---|---|---|---|---|
| | | treatment | power | | Flow Rate | Monomer | parameters, | Thickness | Abrasion, |
| Example # | Substrate | gas, Ar/O₂ | (W) | Monomer | (ml/min) | T (° F.) | Ar gas | (μm)* | cycles |
| 1 | 1 | | | | | | | 0 | 23 |
| 2 | 2 | | | | | | | 0 | 49 |
| 3 | 2 | 80/20 | 1000 | SR-9003 | 8 | 540 | 9 kV, 90 mA, | 3.5 | 56 |
| | | | | | | | Ar | | |
| 4 | 2 | 80/20 | 1000 | SR-9012 | 6 | 540 | 9 kV, 90 mA, | 3.4 | 53 |
| | | | | | | | Ar | | |
| 5 | 2 | 80/20 | 1000 | SR-351 | 10 | 540 | 9 kV, 90 mA, | 3.1 | 57 |
| | | | | | | | Ar | | |
| 6 | 2 | 80/20 | 1000 | SR-351 | 20 | 540 | 9 kV, 90 mA, | 6.3 | 53 |
| | | | | | | | Ar | | |
| 7 | 2 | 80/20 | 1000 | SR-531 | 6 | 540 | 9 kV, 90 mA, | 6.4 | 51 |
| | | | | | | | Ar | | |
| 8 | 2 | 80/20 | 1000 | SR-531 | 10 | 540 | 9 kV, 90 mA, | 3.5 | 53 |
| | | | | | | | Ar | | |
| 9 | 2 | 80/20 | 1000 | CD-262 | 5 | 540 | 9 kV, 90 mA, | 1.4 | 55 |
| | | | | | | | Ar | | |
| 10 | 2 | 80/20 | 1000 | CD-262 | 15 | 540 | 9 kV, 90 mA, | 3.0 | 59 |
| | | | | | | | Ar | | |
| 11 | 1 | 80/20 | 1000 | CD-262 | 15 | 540 | 9 kV, 90 mA, | 3 | 31 |
| | | | | | | | Ar | | |
| 12 | 1 | 80/20 | 1000 | CD-262 | 22 | 540 | 9 kV, 90 mA, | 4.5 | 31 |
| | | | | | | | Ar | | |

The acrylic monomers were polymerized on the nonwoven materials by the following process steps:
a) Plasma treatment to pre-treat the nonwoven web sample.
b) Transfer the nonwoven web sample to a cooled drum inside a vacuum chamber.
c) Use flash evaporation system to deliver the monomer inside the vacuum chamber.
d) Condense the flash evaporated acrylic monomer onto the web that's sitting on the chilled drum.
e) Expose the condensed monomer to an e-beam for graft polymerization or curing.

In another series of examples, nonwoven materials (Spunbond/meltblown/spunbond samples) were treated with abrasion-resistant HMDSO treatments as set forth in Table 3. As above, Substrate 1 was a 1.2 gsm polypropylene SMS sample, and Substrate 2 was a 1.85 gsm polypropylene SMS sample. The monomer applied was HMDSO available from Sartomer Company, Inc. of Exton, Pa., USA. The process used was similar to that described above, except the HMDSO was used in place of the acrylic monomer.

TABLE 3
HMDSO Examples

| | | | | Argon | HMDSO | | | |
|---|---|---|---|---|---|---|---|---|
| | | Line | | flow | Flow | Plasma | | Taber |
| | | speed | Sweep | rate | rate | Power | Watt | Abrasion, |
| Example # | Material | (ft/min) | Gas | (sccm) | (ml/min) | (kW) | Density | cycles |
| 13 | 1 | | | | | | | 6.0 |
| 14 | 2 | | | | | | | 30.0 |
| 15 | 1 | 20 | Argon | 10 | 5 | 0.5 | 20 | 9.6 |
| 16 | 2 | 20 | Argon | 10 | 5 | 0.5 | 20 | 43.6 |

As can be seen in Tables 2 and 3, values for Taber Abrasion generally increased (improved) with application of the abrasion-resistant treatments to the nonwoven samples.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged either in whole or in part. Furthermore, those of ordinary skill in the art will appreciate that the foregoing description is by way of example only, and is not intended to limit the invention so further described in the appended claims.

We claim:

1. An abrasion resistant nonwoven fabric comprising fibers having an external surface, the external surface being covered with a treatment selected from the group consisting of organosilicone compounds applied by plasma treatment in inert gas without the presence of oxygen and acrylic monomers having a Tg greater than or equal to 20 degrees C. applied onto the nonwoven fabric and subsequently surface grafted and crosslinked via exposure to plasma glow discharge or e-beam without the presence of oxygen.

2. The nonwoven fabric of claim 1 wherein the organosilicone compound is hexamethyl disiloxane.

3. The nonwoven fabric of claim 1 wherein the treated fibers have a hydrophobic outer surface.

4. The nonwoven fabric of claim 1 wherein the organosilicone compound on the external surface of the fibers has a thickness of about 0.1 microns to about 1.0 micron.

5. The nonwoven fabric of claim 1 wherein the treatment has a substantially uniform thickness on the external surface of the fibers.

6. The nonwoven fabric of claim 1 wherein the surface tension of the acrylic monomer is less than or equal to about 45 dynes/centimeter.

7. The nonwoven fabric of claim 1 wherein the plasma glow discharge treatment and crosslinking takes place in an inert gas, optionally helium or argon.

8. The nonwoven fabric of claim 1 wherein the crosslinked acrylic on the external surface of the fibers has a thickness of about 1 micron to about 7 microns.

9. The nonwoven fabric of claim 1 wherein the fibers are thermoplastic fibers, optionally polypropylene fibers.

10. The nonwoven fabric of claim 1 wherein the nonwoven fabric comprises two layers of spunbond fibers on either side of a meltblown fiber layer.

11. A process of making an abrasion-resistant nonwoven fabric comprising providing a nonwoven fabric comprising fibers having an external surface, applying a treatment selected from the group consisting of organosilicone compounds applied by plasma glow discharge or e-beam in inert gas without the presence of oxygen and acrylic monomers having a Tg greater than or equal to 20 degrees C. applied onto the nonwoven fabric and subsequently surface grafted and crosslinked via exposure to plasma treatment and crosslinking without the presence of oxygen to form treated fibers.

12. The process of claim 11 wherein the organosilicone compound is hexamethyl disiloxane.

13. The process of claim 11 wherein the treated fibers have a hydrophobic outer surface.

14. The process of claim 11 wherein the organosilicone compound on the external surface of the fibers has a thickness of about 0.1 microns to about 1.0 micron.

15. The process of claim 11 wherein the treatment has a substantially uniform thickness on the external surface of the fibers.

16. The process of claim 11 wherein the surface tension of the acrylic monomer is less than or equal to about 45 dynes/centimeter.

17. The process of claim 11 wherein the plasma treatment and crosslinking takes place in an inert gas, optionally helium or argon.

18. The process of claim 11 wherein the crosslinked acrylic on the external surface of the fibers has a thickness of about 1 micron to about 7 microns.

19. The process of claim 11 wherein the fibers are polypropylene fibers.

20. The process of claim 11 wherein the nonwoven fabric comprises two layers of spunbond fibers on either side of a meltblown fiber layer.
